(19) United States
(12) Patent Application Publication
(10) Pub. No.: US 2011/0127931 A1
(43) Pub. Date: Jun. 2, 2011

(54) LIGHT SOURCE DEVICE AND ILLUMINATION APPARATUS

(75) Inventor: Satoru Tamura, Osaka-shi (JP)

(73) Assignee: SHARP KABUSHIKI KAISHA, Osaka-shi, Osaka (JP)

(21) Appl. No.: 13/002,132

(22) PCT Filed: Jun. 9, 2009
(86) PCT No.: PCT/JP2009/060507

§ 371 Date: Dec. 30, 2010

(30) Foreign Application Priority Data
Jul. 2, 2008 (JP) 2008-173711

(51) Int. Cl. H05B 37/02

(52) U.S. Cl. 315/312

(57) ABSTRACT

To provide a light source device and an illumination apparatus capable of reducing electric power loss. The parent module 10 has chip LEDs 1, a constant current power supply IC 12 for supplying a constant current to the chip LEDs 1, a resistor 15 as adjusting means for adjusting an output current of the constant current power supply IC 12, input/output connectors CN1-CN4, chip jumpers 2-9. By attaching the chip jumper 2 and not attaching the chip jumper 3, the electrical path of the connector CN1 is connected to the input terminal of the constant current power supply IC 12. By arranging the other chip jumpers 4-9 as described above, 24 V connected externally to the connector CN1 is supplied to an external device through the connector CN2, and the output current of the constant current power supply IC 12 is supplied to an external device through the connectors CN3 and CN4.

This application is the normal phase under 35 U.S.C. §371 of PCT International Application No. PCT/JP2009/060507 which has an International filing date of Jun. 9, 2009 and designated the United States of America.

### BACKGROUND

1. Technical Field

The present invention relates to a light source device for use in an illumination apparatus, such as a signboard, a sign, a display board, and lighting equipment, and also relates to an illumination apparatus comprising the light source device.

2. Description of Related Art

A variety of signboards and signs are used for shops, buildings, public facilities, roads etc. They include light sources inside so that the display of the signboards and signs is recognized not only in the daylight, but also in the night time.

In recent years, there is a tendency to use a light emitting diode as a light source in order to provide a long-life light source and save electric power.

For example, there is disclosed a light emitting diode assembly for an illumination signboard. The light emitting diode assembly comprises a plurality of light emitting diodes mounted on a printed circuit board, and a case containing a constant voltage circuit and a constant current circuit for supplying a required dc voltage to the light emitting diodes. The light emitting diode assemblies are arranged in a zigzag fashion on the top surface of an illumination signboard (see Japanese Patent Application Laid-Open No. 2004-310090).

### SUMMARY

Since each of the light emitting diode assemblies for an illumination signboard disclosed in Japanese Patent Application Laid-Open No. 2004-310090 has a constant voltage circuit and a constant current circuit for driving a light emitting diode by supplying a direct current to the light emitting diode, each of light emitting diode assemblies causes an electric power loss during conversion to a direct current. Hence, when a light source device for use in an illumination signboard or the like is configured by connecting a plurality of light emitting diode assemblies, an electric power loss occurs in each light emitting diode assembly, and thus there is a problem that the electric power loss in the entire light source device is large.

The present invention has been made to solve the above-mentioned problem, and an object of the invention is to provide a light source device capable of reducing electric power loss, and an illumination apparatus comprising the light source device.

A light source device according to the present invention is a light source device comprising a plurality of modules, and characterized in that a plurality of the modules form a group and include: a first module having a light source for each group; and a second module having a driving circuit for driving the light source of the first module.

According to the present invention, the light source device comprises a plurality of modules which form a group and include a first module having a light source for each group, and a second module which has a driving circuit for driving the light source of the first module. Thus, since it is not necessary to provide every module with a driving circuit, electric power loss in the entire light source device is reduced.

The light source device according to the present invention is characterized in that the group includes a plurality of first modules, and that the light source of a plurality of the first modules is driven by sharing the driving circuit of the second module.

According to the present invention, the group includes a plurality of first modules, and the light source of a plurality of the first modules is driven by sharing the driving circuit of the second module. Thus, since the driving circuit is shared, the electric power loss in the entire light source device is reduced.

The light source device according to the present invention is characterized in that each of the first modules and the second module has a plurality of connectors on its peripheral portion, wherein connectors to be connected to each other are selected from a plurality of the connectors according to an arrangement of the first modules and the second module to allow a flexible arrangement of the first modules and the second module.

According to the present invention, each of the first modules and the second module has a plurality of connectors on its peripheral portion, and connectors to be connected to each other are selected from a plurality of the connectors according to an arrangement of the first modules and the second module, thereby allowing a flexible arrangement of the first modules and the second module. Hence, the degree of freedom in arranging the first modules and the second module is increased and flexible arrangement is achieved.

The light source device according to the present invention is characterized in that the first module and the second module include a first substrate and a second substrate, respectively, on which the light sources are mounted, and have the same number of the light sources per area of substrate of the first module and the second module.

According to the present invention, in the light source device, the first module and the second module include the first substrate and the second substrate, respectively, on which the light sources are mounted, and have the same number of the light sources per area of substrate of the first module and the second module. Therefore, even when the number of the first modules or the second modules is increased or decreased according to the shape and size of a signboard, sign etc., the number of the light sources per area of substrate does not vary, thereby achieving uniform brightness irrespective of the shape and size of the signboard, sign, etc.

The light source device according to the present invention is characterized in that the first substrate and the second substrate have the same size.

According to the present invention, the first substrate and the second substrate have the same size. Therefore, by increasing or decreasing the number of the first modules or the second modules, it is possible to match the light source device with the shape and size of a signboard, a sign etc.

The light source device according to the present invention is characterized in that the second module includes adjusting means for adjusting an output of the driving circuit according to the number of the first modules to be driven.

In the present invention, the second module includes adjusting means for adjusting an output of the driving circuit according to the number of the first modules to be driven. The driving circuit is, for example, a current circuit for supplying an electric current to the light source, and the adjusting means is a resistive element for adjusting an output current of the current circuit. Hence, a similar current flows in the light source irrespective of the number of the first modules to be driven by the second module.

The light source device according to the present invention is characterized in that the second module and/or the first module includes a plurality of input/output connectors, and opening/closing sections connected to the connectors, respectively, and capable of opening and closing an electrical path between the connector and the driving circuit, an electrical path between the connector and an output terminal of the driving circuit, and/or an electrical path between the connector and the light source.

According to the present invention, the second module includes a plurality of input/output connectors, and opening/closing sections connected to the connectors, respectively, and capable of opening and closing an electrical path between the connector and the driving circuit (for example, the input side of the driving circuit), and an electrical path between the connector and an output terminal of the driving circuit. For example, when the second module includes four connectors, namely, first to fourth connectors, the opening and closing sections close the electrical path between the first connector and the driving circuit, the second connector and the driving circuit, and also open the electrical path between the connectors and the output terminal of the driving circuit. Moreover, the opening and closing sections close the electrical path between the third connector and the output terminal of the driving circuit, the fourth connector and the output terminal of the driving circuit, and also open the electrical path to the driving circuit. When an input power supply is connected to the first connector, the input power supply is taken out from the second connector. It is also possible to take out an output of the driving circuit from the third connector and the fourth connector. Hence, when the second connector of a second module is connected to another second module and the third connector and the fourth connector are connected to a first module, an input voltage is supplied from the second module to another second module and an output of the driving circuit is supplied to the first module. It is thus possible to easily connect the second modules to each other, or easily connect the second module and the first module.

The first module includes a plurality of input/output connectors, and opening/closing sections connected to the connectors, respectively, and capable of opening and closing electrical paths between the connectors and the light source. For example, suppose that the first module includes four connectors, namely, first to fourth connectors, and the opening and closing sections close the electrical paths between the first to fourth connectors and the light source. When the first connector is connected to an output of the driving circuit of another module, the output of the driving circuit is similarly taken out from the second to fourth connectors. Thus, it is possible to easily connect the first module and the second module, or easily connect the first modules to each other.

The light source device according to the present invention is characterized in that the light source is a light emitting diode.

According to the present invention, the light source is a light emitting diode. Therefore, it is possible to provide a long-life light source device and save electric power.

An illumination apparatus according to the present invention is characterized by comprising the above-described light source device of the present invention.

According to the present invention, the illumination apparatus comprises the above-described light source device. Hence, it is possible to provide an illumination apparatus capable of reducing electric power loss.

According to the present invention, it is possible to realize a light source device capable of reducing electric power loss, and a signboard, a display board, illumination equipment etc. incorporating the light source device. The light source device comprises a plurality of modules which form a group, and there is no need to provide every module with a driving circuit. Therefore, electric power loss in the entire light source device is reduced. Moreover, since it is possible share the driving circuit, electric power loss in the entire light source device is reduced. Further, the degree of freedom in arranging a plurality of modules in the light source device is increased, and flexible arrangement is realized. In addition, even when the shape and size of a signboard, a sign etc. varies according to where it is mounted, it is possible to flexibly match the light source device with varied shapes and sizes and use it for the signboard, a sign etc.

The above and further objects and features of the invention will more fully be apparent from the following detailed description with accompanying drawings.

### BRIEF DESCRIPTION OF THE SEVERAL VIEWS OF THE DRAWINGS

FIG. 1 is an external perspective view of a light source device according to the present invention.

FIG. 2 is a circuit diagram illustrating the configuration of a parent module.

FIG. 3 is an explanatory view illustrating one example of mount arrangement on a substrate of the parent module.

FIG. 4 is a circuit diagram illustrating the configuration of a child module.

FIG. 5 is a cross sectional view illustrating one example of a connection between the modules.

FIG. 6 is an explanatory view illustrating a first example of the arrangement of the parent modules and child modules.

FIG. 7 is an explanatory view illustrating a second example of the arrangement of the parent modules and child modules.

FIG. 8 is an explanatory view illustrating a third example of the arrangement of the parent modules and child modules.

FIG. 9 is an explanatory view illustrating a fourth example of the arrangement of the parent modules and child modules.

FIG. 10 is an explanatory view illustrating a fifth example of the arrangement of the parent modules and child modules.

FIG. 11 is an explanatory view illustrating a sixth example of the arrangement of the parent modules and child modules.

FIG. 12 is an explanatory view illustrating a seventh example of the arrangement of the parent modules and child modules.

FIG. 13 is an explanatory view illustrating an eighth example of the arrangement of the parent modules and child modules.

FIG. 14 is an explanatory view illustrating a ninth example of the arrangement of the parent modules and child modules.

FIG. 15 is an explanatory view illustrating a tenth example of the arrangement of the parent modules and child modules.

FIG. 16 is an explanatory view illustrating an eleventh example of the arrangement of the parent modules and child modules.

FIG. 17 is an external perspective view of a light source device of Embodiment 2.

FIG. 18 is an external perspective view of a light source device of Embodiment 3.

### DETAILED DESCRIPTION

### Embodiment 1

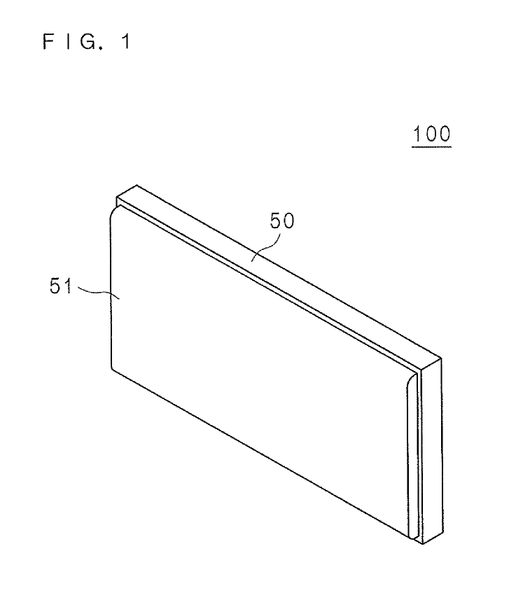

The following will explain the present invention with reference to the drawings illustrating an embodiment thereof FIG. 1 is an external perspective view of a light source device 100 according to the present invention. The light source device 100 according to the present invention is for use in illumination apparatuses, such as signboards, signs, display boards, and lighting equipment. The following will explain a case where the light source device 100 is used in a signboard. As illustrated in FIG. 1, the light source device 100 comprises: a housing 50 which is mountable to an external wall of a building, such as a shop, and capable of storing therein a plurality of modules including a light source mounted on a substrate; and an acrylic plate 51 which has letters, symbols, figures or patterns drawn thereon and is attached to the housing 50. With the stored light source, the entire acrylic plate 51 evenly emits light at a desired illuminance level.

The light source device 100 comprises two types of modules, namely a child module as a first module, and a parent module as a second module. One or a plurality of child modules is/are connected to one parent module.

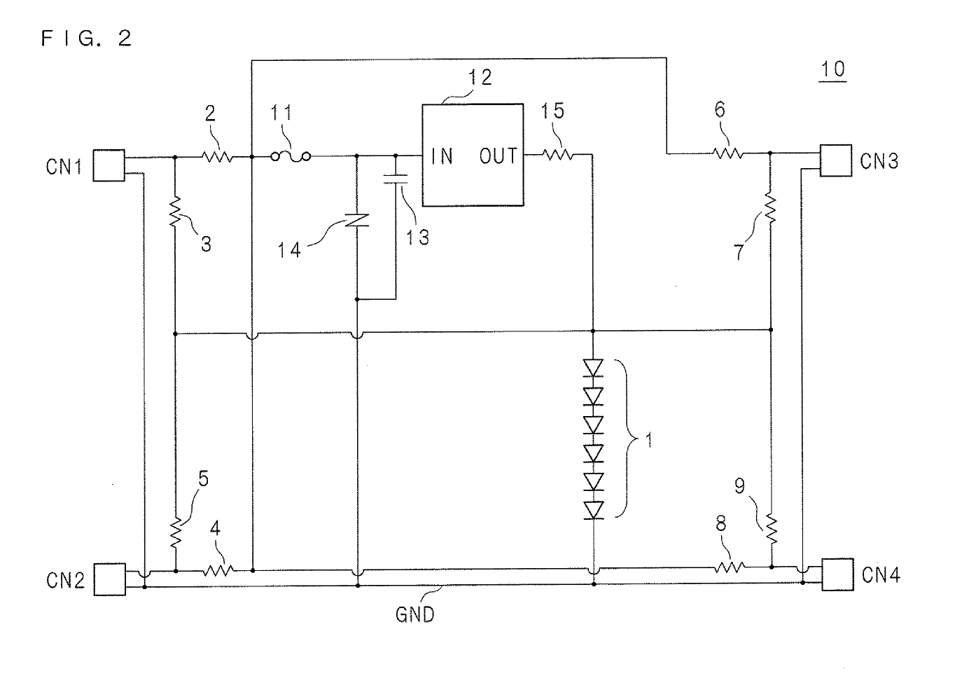

FIG. 2 is a circuit diagram illustrating the configuration of a parent module 10. The parent module 10 comprises: six chip LEDs (white light emitting diodes) 1 as a light source mounted with a suitable space between them on a later-described substrate; a constant current power supply IC 12 as a driving circuit for supplying a constant current to the chip LEDs 1; a resistor 15 as adjusting means for adjusting an output current of the constant current power supply IC 12; input/output connectors CN1-CN4; chip jumpers 2 and 3 as an opening and closing section connected to the connector CN1; chip jumpers 4 and 5 as an opening and closing section connected to the connector CN2; chip jumpers 6 and 7 as an opening and closing section connected to the connector CN3; chip jumpers 8 and 9 as an opening and closing section connected to the connector CN4; a fuse 11 for detecting an overcurrent and protecting the light source device 100; a varistor 14 for protecting the constant current power supply IC 12 from a surge voltage entering from outside; and a capacitor 13 for absorbing noise.

The number of child modules to be driven by the parent module 10 is changeable by changing the value of the resistor 15. For example, in the case where the number of child modules to be driven is increased, the resistance of the resistor 15 is decreased, whereas in the case where the number of child modules to be driven is decreased, the resistance of the resistor 15 is increased. In the above example, although the output current of the constant current power supply IC 12 is adjusted by only the resistor 15, the output current may be adjusted by other structure, such as a combination of a resistive element and a transistor.

A pair of chip jumpers 2 and 3 functions as an opening and closing section. An electrical path is closed by attaching one of the chip jumpers, and an electrical path is opened by not attaching the other. For example, by attaching the chip jumper 2 and not attaching the chip jumper 3, an electrical path of the connector CN1 (an electrical path which is not GND) is connected to the input terminal (IN) of the constant current power supply IC 12. An external power supply (for example, 24 V) is connected to the connector CN1. Note that the voltage of the external power supply is not limited to 24 V and may be other voltage, such as, for example, 33 V.

Similarly, a pair of chip jumpers 4 and 5 functions as an opening and closing section. An electrical path is closed by attaching one of the chip jumpers, and an electrical path is opened by not attaching the other. For example, by attaching the chip jumper 4 and not attaching the chip jumper 5, an electrical path of the connector CN2 (an electrical path which is not GND) is connected to the input terminal (IN) of the constant current power supply IC 12, that is, 24 V supplied to the connector CN2, and 24 V is supplied to an external device.

Similarly, a pair of chip jumpers 6 and 7 functions as an opening and closing section. An electrical path is closed by attaching one of the chip jumpers, and an electrical path is opened by not attaching the other. For example, by attaching the chip jumper 7 and not attaching the chip jumper 6, an electrical path of the connector CN3 (an electrical path which is not GND) is connected to the output terminal (OUT) of the constant current power supply IC 12, and the output current of the constant current power supply IC 12 is supplied to an external device.

Similarly, a pair of chip jumpers 8 and 9 functions as an opening and closing section. An electrical path is closed by attaching one of the chip jumpers, and an electrical path is opened by not attaching the other. For example, by attaching the chip jumper 9 and not attaching the chip jumper 8, an electrical path of the connector CN4 (an electrical path which is not GND) is connected to the output terminal (OUT) of the constant current power supply IC 12, and the output current of the constant current power supply IC 12 is supplied to an external device.

By arranging the chip jumpers 2-9 as described above, 24 V connected externally to the connector CN1 is supplied to an external device through the connector CN2, and the output current of the constant current power supply IC 12 is supplied to an external device through the connectors CN3 and CN4. The combinations of the chip jumpers 2-9 to be attached or not to be attached are not limited to those mentioned in the above examples, and may be varied according to the number or a combination of the parent modules 10 and later-described child modules stored in the light source device 100.

The chip jumpers 2-9 as the opening and closing sections are merely one example, and the opening and closing sections are not limited to them. Other switch, such as a dip switch, may be used if it is able to open and close an electrical path. The number of chip LEDs 1 is not limited to six, and any number of chip LEDs 1 may be mounted.

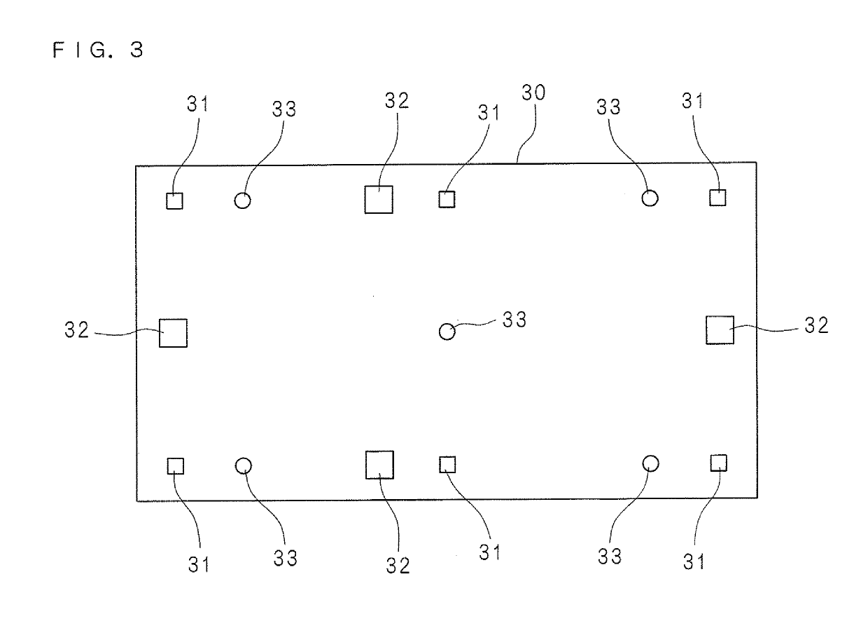

FIG. 3 is an explanatory view illustrating one example of mount arrangement on a substrate 30 of the parent module 10. The substrate 30 illustrated in FIG. 3 can be used in later-described child modules. The size of the substrate 30 is, for example, 160 mm in length and 86 mm in width, and the substrate 30 has mounting planes 31 for mounting the chip LEDs 1, attachment planes 32 for attaching the connectors CN1-CN4, and attachment holes 33 for attaching the substrate 30 to an aluminum plate, a fixture bar etc. For example, when six chip LEDs 1 are to be mounted, the chip LEDs 1 are arranged at intervals of 70 mm in a lengthwise direction and 68 mm in a widthwise direction.

The attachment plane 32 is provided near the center of each side of the peripheral portion of the substrate 30. Therefore, when the parent modules 10 and the child modules are arranged in vertical and horizontal directions, the distance between the connectors is shortened. Moreover, by placing a connector on each side of the rectangular substrate 30, even when a combination of the parent modules 10 and the child modules are arranged in various forms, connectors for connecting adjacent modules exist near them. Thus, it is possible to flexibly deal with various forms of arrangement of the modules.

Note that the position of attaching the connectors CN1-CN4 is merely one example, and the present invention is not limited to this. In addition, the number of connectors per substrate 30 is not limited to four. For example, when the substrate 30 is in the shape of a hexagon, if six connectors are arranged on each of the six sides, it is possible to flexibly deal with various forms of arrangement of the modules in the same way as in the above-mentioned case of the rectangular substrate. When the substrate is in the shape of a polygon, similar effects are obtained by arranging connectors corresponding to the number of the sides of the polygon. Further, even when the substrate has a circular shape, it is possible to flexibly deal with various forms of arrangement of the modules by providing a plurality of connectors on the outer peripheral portion of the substrate.

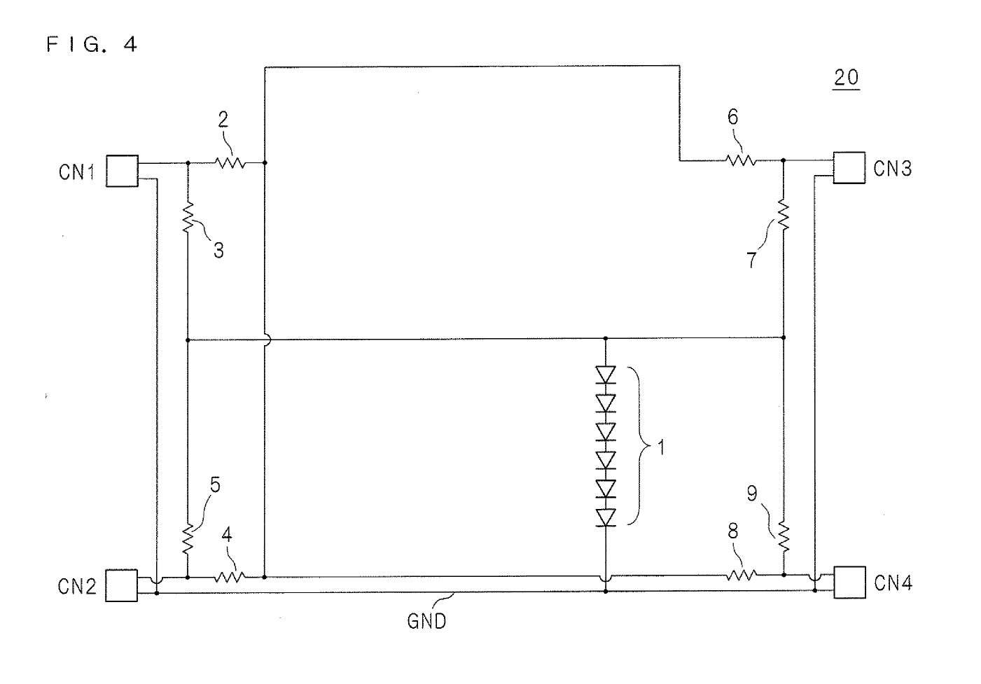

FIG. 4 is a circuit diagram illustrating the configuration of a child module 20. The child module 20 comprises: six chip LEDs (white light emitting diodes) 1 mounted on the above-mentioned substrate 30, input/output connectors CN1-CN4; chip jumpers 2 and 3 as an opening and closing section connected to the connector CN1; chip jumpers 4 and 5 as an opening and closing section connected to the connector CN2; chip jumpers 6 and 7 as an opening and closing section connected to the connector CN3; and chip jumpers 8 and 9 as an opening and closing section connected to the connector CN4.

A pair of chip jumpers 2 and 3 functions as an opening and closing section. An electrical path is closed by attaching one of the chip jumpers, and an electrical path is opened by not attaching the other. For example, by attaching the chip jumper 3 and not attaching the chip jumper 2, an electrical path of the connector CN1 (an electrical path which is not GND) is connected to the anode of the chip LEDs 1 connected in series. An output current of the constant current power supply IC 12 is supplied from the parent module 10 or the child module 20 to the connector CN1.

A pair of chip jumpers 4 and 5 functions as an opening and closing section. An electrical path is closed by attaching one of the chip jumpers, and an electrical path is opened by not attaching the other. For example, by attaching the chip jumper 5 and not attaching the chip jumper 4, an electrical path of the connector CN2 (an electrical path which is not GND) is connected to the anode of the chip LED 1, and the output current of the constant current power supply IC 12 supplied from the connector CN1 is supplied to an external device.

By arranging a pair of chip jumpers 6 and 7 in the same manner as for the chip jumpers 4 and 5, the output current of the constant current power supply IC 12 supplied from the connector CN1 is supplied to an external device through the connector CN3. In the case where the connector CN3 is not used, the chip jumpers 6 and 7 are not attached. For the chip jumpers 8 and 9, the same thing as that for the chip jumpers 6 and 7 is said.

In the case where the chip jumpers 3, 5, 7 and 9 are attached but the chip jumpers 2, 4, 6 and 8 are not attached, all the connectors CN1, 2, 3 and 4 are equally used as input connectors. On the other hand, in the case where the chip jumpers 3, 5, 7 and 9 are not attached but the chip jumpers 2, 4, 6 and 8 are attached, the output current of the constant current power supply IC 12 input from either of the connectors CN1, 2, 3 and 4 is supplied to an external device without supplying it to the chip LED 1.

Thus, by attaching the chip jumpers, it is possible to adjust a child module 20 which emits light by supplying a constant current to the chip LED 1 and a child module 20 which does not emit light by not supplying the constant current to the chip LED. Moreover, in a light source device in which a plurality of child modules are arranged and connected, it is possible to achieve thinned-out lighting with reduced light by arranging alternately child modules 20 which emit light and child modules 20 which do not emit light. Thus, since brightness is controllable according to time and location, electric power is saved.

By arranging chip jumpers 2-9 as described above, for example, a current for driving the chip LED 1 connected to the connector CN1 from the parent module 10 or a child module 20 is supplied to other child module 20 through any or all of the connectors CN2 to CN4. The combinations of the chip jumpers 2-9 to be attached or not to be attached are not limited to those mentioned in the above examples, and may be varied according to the number or a combination of the parent modules 10 and child modules 20 stored in the light source device 100.

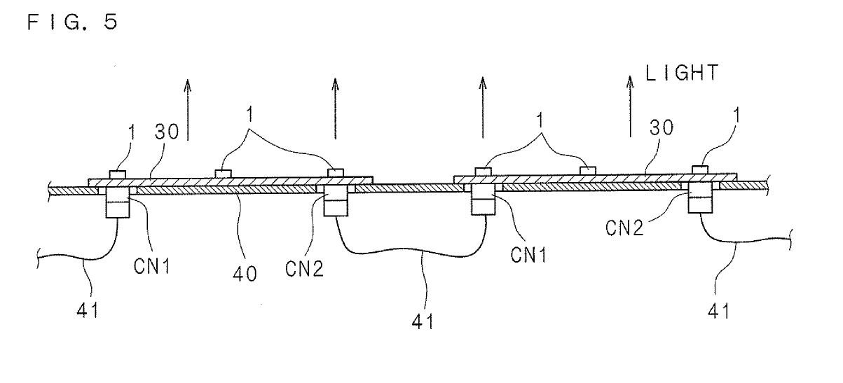

FIG. 5 is a cross sectional view illustrating one example of a connection between the modules. In FIG. 5, 40 is an aluminum plate for mounting the parent module 10 and child module 20. The aluminum plate 40 has a size capable of mounting a given number of parent modules 10 and child modules 20 with an appropriate distance between them. The connectors CN1 and CN2 are attached to a surface of the substrate 30 opposite to a surface where the chips LED 1 are mounted. It is thus possible to prevent light from the chip LED 1 from being blocked. In addition, the connectors CN1 and CN2 are electrically connected with a harness 41. Screws for fastening the connectors CN3, CN4 and the substrate 30 to the aluminum plate 40 are not illustrated. The surfaces of the parent module 10 and child module 20 are coated with a transparent resin, such as silicon, fluororesin, and epoxy resin, and water-proof connectors are used for the connectors CN1 to CN4. Thus, the light source device 100 has completely waterproof specifications and may be installed outdoor. Note that it is also possible to attach the connectors CN1-CN4 to the surface on which the chip LEDs 1 are mounted. This enables a reduction in the overall thickness (depth) of the light source device 100.

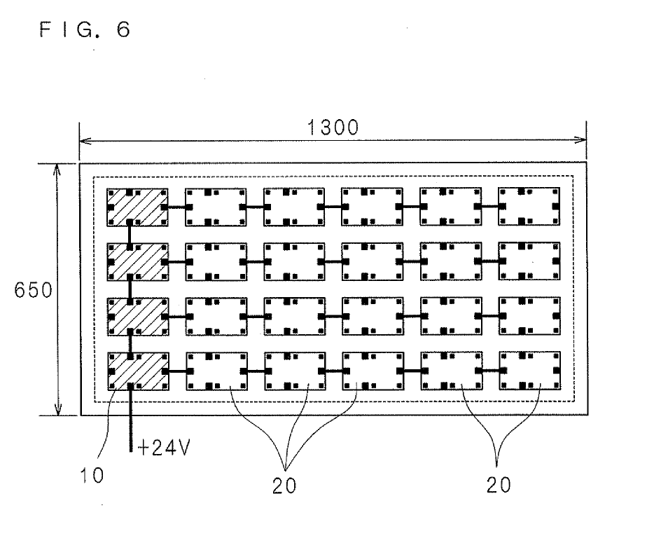

Next, the following will explain an example of the arrangement of the parent modules 10 and child modules 20 of the light source device 100. FIG. 6 is an explanatory view illustrating a first example of the arrangement of the parent modules 10 and child modules 20. In FIG. 6, the external size of the signboard is 1300 mm×650 mm. As illustrated in FIG. 6, four parent modules 10 are placed sideways on an edge of the signboard along a widthwise direction, and each parent module 10 drives five child modules 20. The child modules 20 are placed sideways in four rows along a longitudinal direction of the signboard so that each row includes five child modules 20. Therefore, there are four groups, each including one parent module 10 and five child modules 20. In each group, the driving circuit of the parent module 10 is shared to drive the chip LEDs 1 mounted as light sources in the parent module 10 and a plurality of child modules 20.

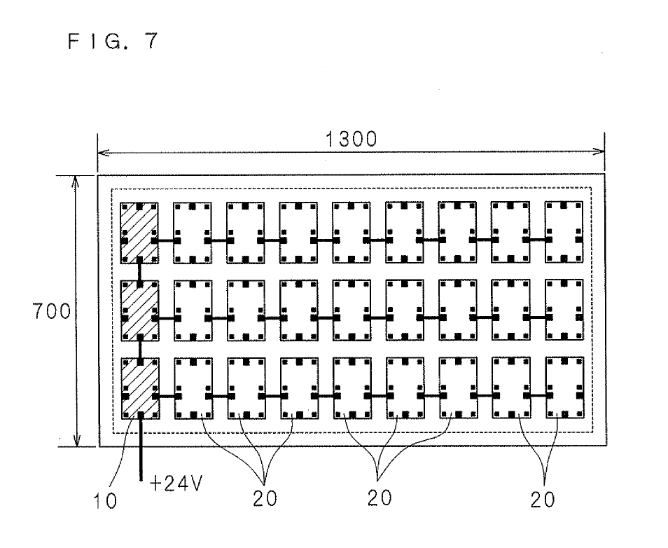

FIG. 7 is an explanatory view illustrating a second example of the arrangement of the parent modules 10 and child modules 20. In FIG. 7, the external size of the signboard is 1300 mm×700 mm. As illustrated in FIG. 7, three parent modules 10 are placed lengthwise on an edge of the signboard along a widthwise direction, and each parent module 10 drives eight child modules 20. The child modules 20 are placed lengthwise in three rows along a longitudinal direction of the signboard so that each row includes eight child modules 20. Therefore, there are three groups, each including one parent module 10 and eight child modules 20. In each group, the driving circuit of the parent module 10 is shared to drive the chip LEDs 1 mounted as light sources in the parent module 10 and a plurality of child modules 20.

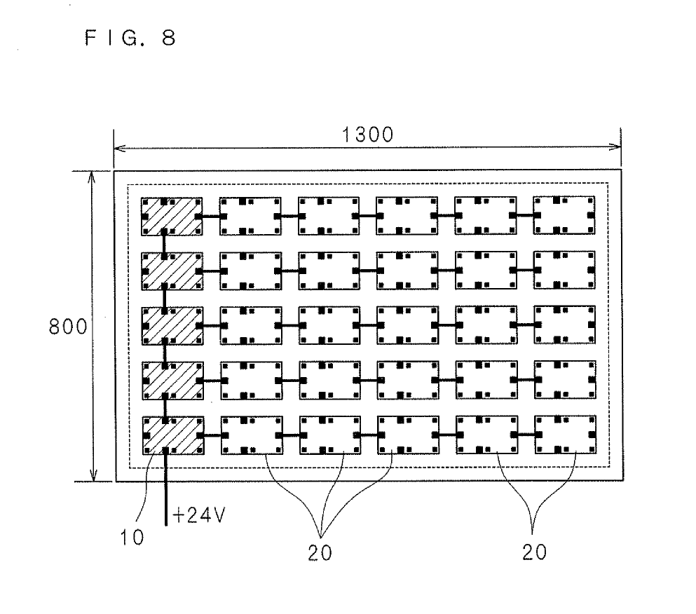

FIG. 8 is an explanatory view illustrating a third example of the arrangement of the parent modules 10 and child modules 20. In FIG. 8, the external size of the signboard is 1300 mm×800 mm. As illustrated in FIG. 8, five parent modules 10 are placed sideways on an edge of the signboard along a widthwise direction, and each parent module 10 drives five child modules 20. The child modules 20 are placed sideways in five rows along a longitudinal direction of the signboard so that each row includes five child modules 20. Therefore, there are five groups, each including one parent module 10 and five child modules 20. In each group, the driving circuit of the parent module 10 is shared to drive the chip LEDs 1 mounted as light sources in the parent module 10 and a plurality of child modules 20.

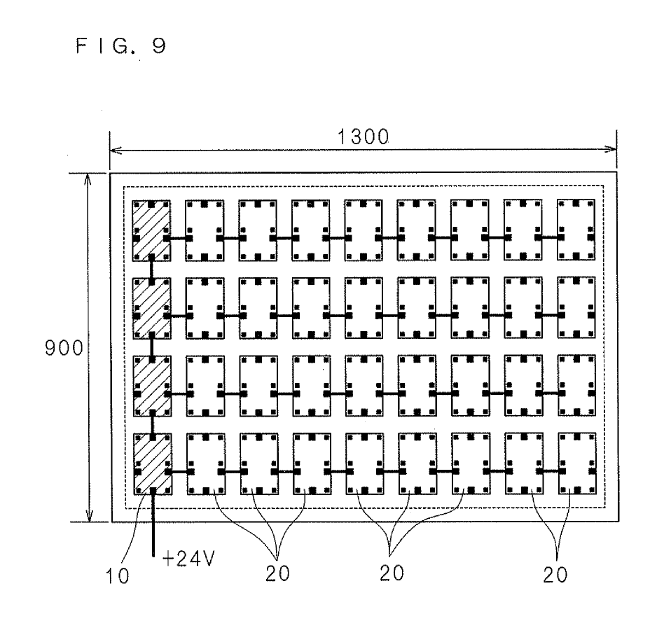

FIG. 9 is an explanatory view illustrating a fourth example of the arrangement of the parent modules 10 and child modules 20. In FIG. 9, the external size of the signboard is 1300 mm×900 mm. As illustrated in FIG. 9, four parent modules 10 are placed lengthwise on an edge of the signboard along a widthwise direction, and each parent module 10 drives eight child modules 20. The child modules 20 are placed lengthwise in four rows along a longitudinal direction of the signboard so that each row includes eight child modules 20. Therefore, there are four groups, each including one parent module 10 and eight child modules 20. In each group, the driving circuit of the parent module 10 is shared to drive the chip LEDs 1 mounted as light sources in the parent module 10 and a plurality of child modules 20.

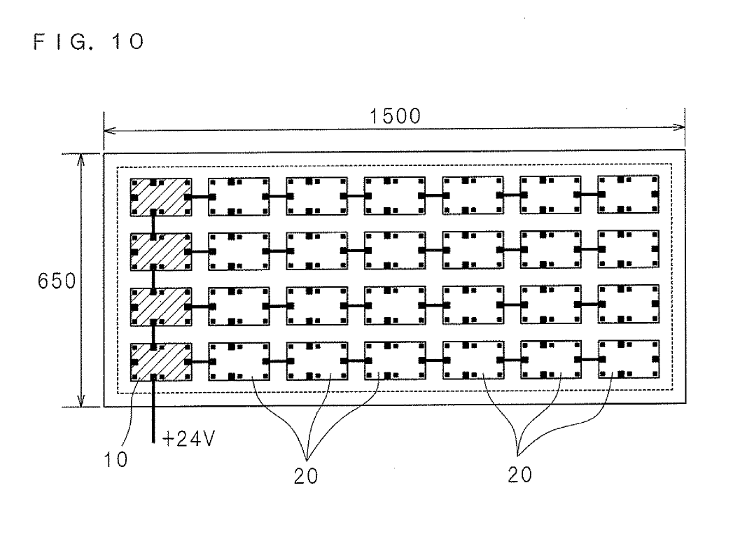

FIG. 10 is an explanatory view illustrating a fifth example of the arrangement of the parent modules 10 and child modules 20. In FIG. 10, the external size of the signboard is 1500 mm×650 mm. As illustrated in FIG. 10, four parent modules 10 are placed sideways on an edge of the signboard along a widthwise direction , and each parent module 10 drives six child modules 20. The child modules 20 are placed sideways in four rows along a longitudinal direction of the signboard so that each row includes six child modules 20. Therefore, there are four groups, each including one parent module 10 and six child modules 20. In each group, the driving circuit of the parent module 10 is shared to drive the chip LEDs 1 mounted as light sources in the parent module 10 and a plurality of child modules 20.

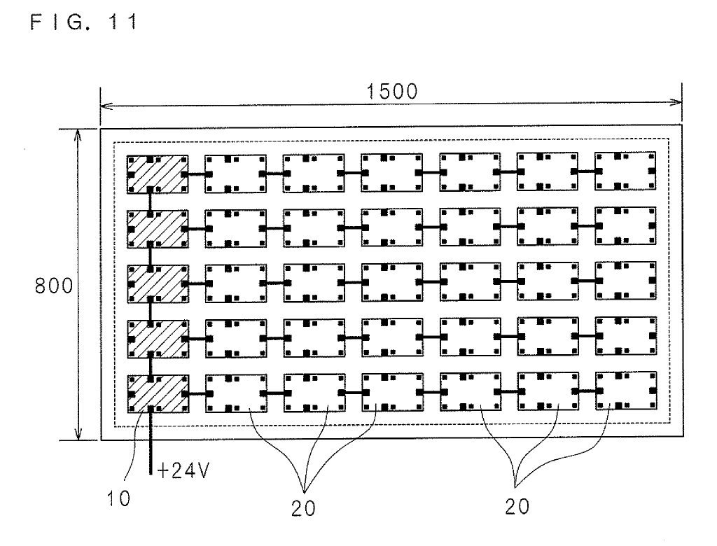

FIG. 11 is an explanatory view illustrating a sixth example of the arrangement of the parent modules 10 and child modules 20. In FIG. 11, the external size of the signboard is 1500 mm×800 mm. As illustrated in FIG. 11, five parent modules 10 are placed sideways on an edge of the signboard along a widthwise direction, and each parent module 10 drives six child modules 20. The child modules 20 are placed sideways in five rows along a longitudinal direction of the signboard so that each row includes six child modules 20. Therefore, there are five groups, each including one parent module 10 and six child modules 20. In each group, the driving circuit of the parent module 10 is shared to drive the chip LEDs 1 mounted as light sources in the parent module 10 and a plurality of child modules 20.

In the above-described example, each of the parent modules 10 is configured to drive the same number of child modules 20. However, the present invention is not limited to this, and the parent module 10 may drive an arbitrary number of child modules 20 within a range of the maximum number of child modules 20 that the parent module 10 can drive. Thus, it is possible to more flexibly deal with signboards having different external shapes. Moreover, since the number of modules to be arranged is not limited to multiples of the number of the parent modules 10, it is possible to adjust the illuminance on the acrylic plates 51 to a more desired value.

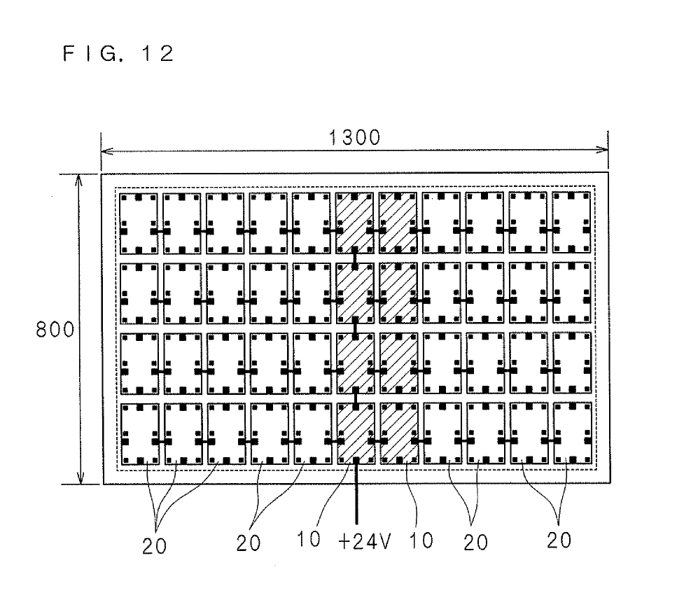

FIG. 12 is an explanatory view illustrating a seventh example of the arrangement of the parent modules 10 and child modules 20. In FIG. 12, the external size of the signboard is 1300 mm×800 mm. As illustrated in FIG. 12, two sets of four parent modules 10 are placed lengthwise along a widthwise direction near the center of the signboard, and each of the parent modules 10 in one of the sets drives five child modules 20 and each of the parent modules 10 in the other set drives four child modules 20. The child modules 20 are placed lengthwise to make four rows of five child modules 20 and four rows of four child modules 20 along a longitudinal direction of the signboard. Therefore, there are four groups, each including one parent module 10 and five child modules 20, and four groups, each including one parent module 10 and four child modules 20. In each group, the driving circuit of the parent module 10 is shared to drive the chip LEDs 1 mounted as light sources in the parent module 10 and a plurality of child modules 20.

In the above-described examples, the child modules 20 are placed sideways or lengthwise in a straight line. However, the present invention is not limited to these examples, and the child modules 20 may be arranged, for example, in a loop.

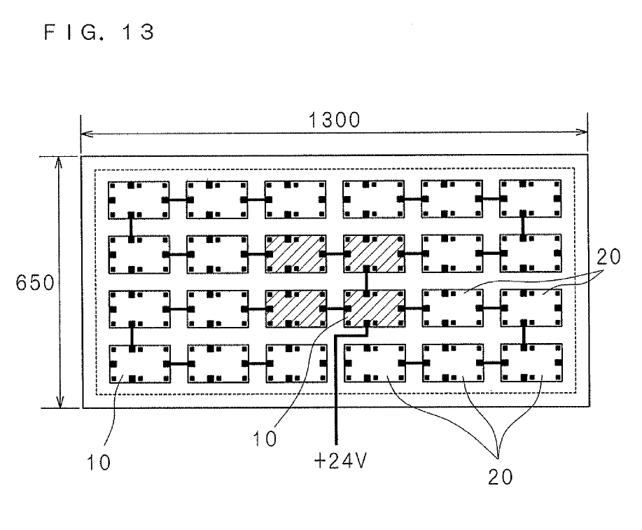

FIG. 13 is an explanatory view illustrating an eighth example of the arrangement of the parent modules 10 and child modules 20. In FIG. 13, the external size of the signboard is 1300 mm×650 mm. As illustrated in FIG. 13, four parent modules 10 are placed sideways adjacent to each other near the center of the signboard, and each parent module 10 drives five child modules 20. The child modules 20 are placed sideways so that five child modules 20 are arranged in two rows along a longitudinal direction of the signboard. Therefore, there are four groups, each including one parent module 10 and five child modules 20. In each group, the driving circuit of the parent module 10 is shared to drive the chip LEDs 1 mounted as light sources in the parent module 10 and a plurality of child modules 20.

In the above-described example, the parent module 10 includes six chip LEDs 1. However, the present invention is not limited to this, and the chip LEDs 1 may be removed from the parent module 10.

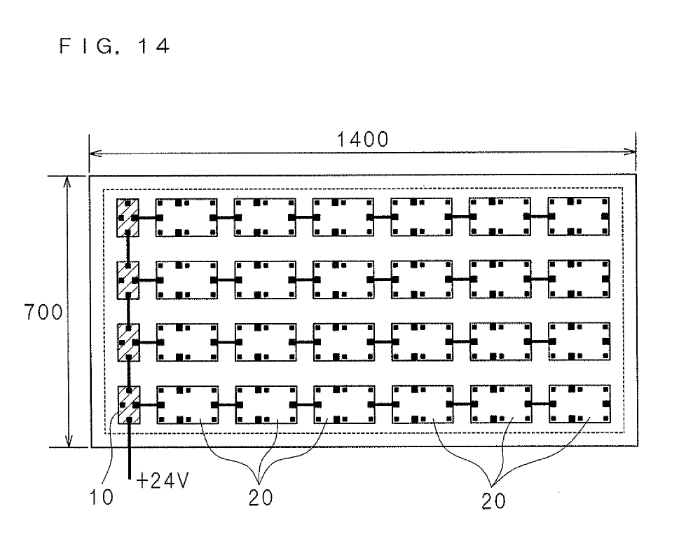

FIG. 14 is an explanatory view illustrating a ninth example of the arrangement of the parent modules 10 and child modules 20. In FIG. 14, the external size of the signboard is 1400 mm×700 mm. As illustrated in FIG. 14, four parent modules 10 are placed sideways on an edge of the signboard along a widthwise direction, and each parent module 10 drives six child modules 20. The child modules 20 are placed sideways in four rows along a longitudinal direction of the signboard so that each row includes six child modules 20. Therefore, there are four groups, each including one parent module 10 and six child modules 20. In each group, the driving circuit of the parent module 10 is shared to drive the chip LEDs 1 mounted as light sources in a plurality of child modules 20.

In this case, since the chip LED 1 is not mounted in the parent module 10, it is possible to make the size of the substrate 30 smaller than the substrate 30 of the child module 20.

In the above-described example, each of the substrates 30 of the parent module 10 and the child module 20 on which the chip LEDs 1 are mounted has the same size. However, the present invention is not limited to this, and the size of the substrate 30 of the parent module 10 and that of the child module 20 may differ from each other.

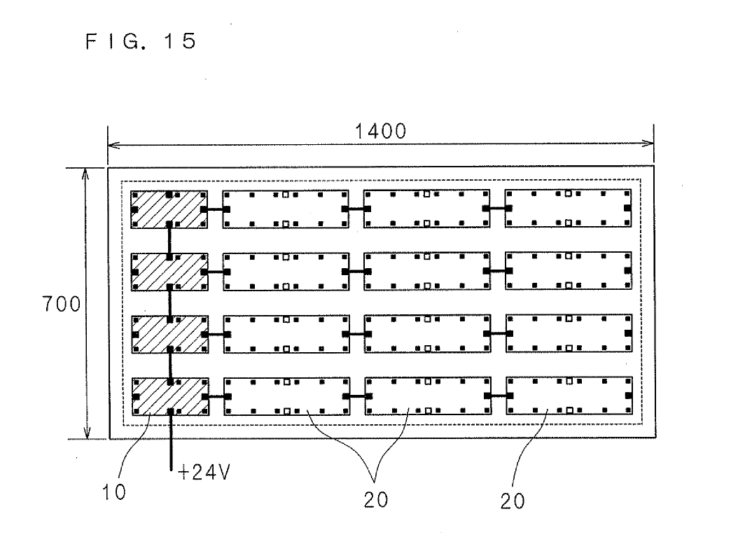

FIG. 15 is an explanatory view illustrating a tenth example of the arrangement of the parent modules 10 and child modules 20. In FIG. 15, the external size of the signboard is 1400 mm×700 mm. As illustrated in FIG. 15, four parent modules 10 are placed sideways on an edge of the signboard along a widthwise direction, and each parent module 10 drives three child modules 20. The child modules 20 are placed sideways in four rows along a longitudinal direction of the signboard so that each row includes three child modules 20. Therefore, there are four groups, each including one parent module 10 and three child modules 20. In each group, the driving circuit of the parent module 10 is shared to drive the chip LEDs 1 mounted as light sources in the parent module 10 and a plurality of child modules 20.

In this case, the size of the substrate 30 of the parent module 10 is a half of the substrate 30 of the child module 20. The number of the chip LEDs 1 mounted in the parent module 10 is six, and the number of the chip LEDs 1 mounted in the child module 20 is twelve. In short, the number of the chip LEDs 1 per area of substrate 30 of the parent module 10 and that of the child module 20 are the same. Hence, even when the number of parent modules 10 and child modules 20 is increased or decreased according to the shape and size of the signboard, sign etc., the number of light sources per area of substrate is the same, thereby achieving uniform brightness irrespective of the shape and size of the signboard, sign etc.

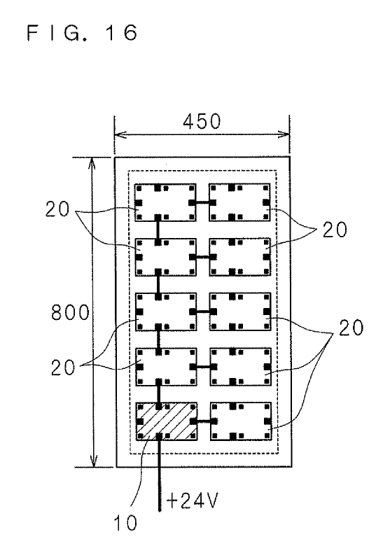

FIG. 16 is an explanatory view illustrating an eleventh example of the arrangement of the parent modules 10 and child modules 20. In FIG. 16, the external size of the signboard is 450 mm×800 mm. As illustrated in FIG. 16, one parent module 10 is placed sideways on an edge of the signboard, and the parent module 10 drives nine child modules 20. The nine child modules 20 are arranged in five rows in the remaining space of the signboard. In the case where a plurality of light source devices 100 are disposed in an area where a signboard is to be mounted, a small gap sometimes remains depending on the area where the signboard is mounted. In the example illustrated in FIG. 16, it is possible to mount the light source device 100 in such a small gap.

### Embodiment 2

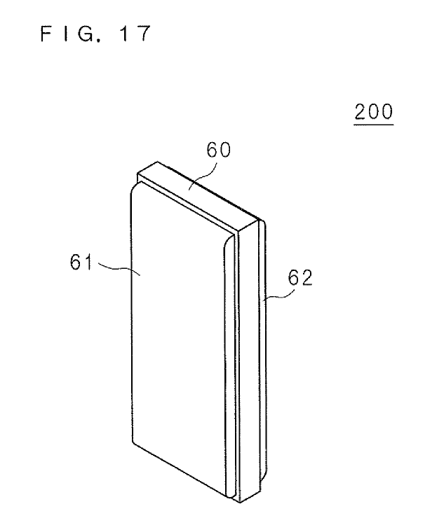

In the above-described embodiment, the light source device 100 is configured to emit light only from one side of a signboard, but the present invention is not limited to this. FIG. 17 is an external perspective view of a light source device 200 of Embodiment 2. The light source device 200 is for use in signboards, signs or display boards, or lighting equipment. As illustrated in FIG. 17, the light source device 200 comprises: a housing 60 which is mountable to a wall or a post (not shown) mounted on the ground and capable of storing therein a plurality of parent modules 10 and child modules 20; and acrylic plates 61 and 62 which have letters, symbols, figures or patterns drawn thereon and are attached to both sides of the housing 60. With the stored chip LEDs 1, the entire acrylic plates 61 and 62 evenly emit light at a desired illuminance level.

In Embodiment 2, the parent modules 10 and child modules 20 are arranged inside the housing 60 so that the rear faces of the substrates 30 (the substrate surface on a side where the connectors are attached) face each other. Since configuration and arrangement examples of the parent modules 10 and child modules 20 are the same as those in Embodiment 1, explanation of them will be omitted.

### Embodiment 3

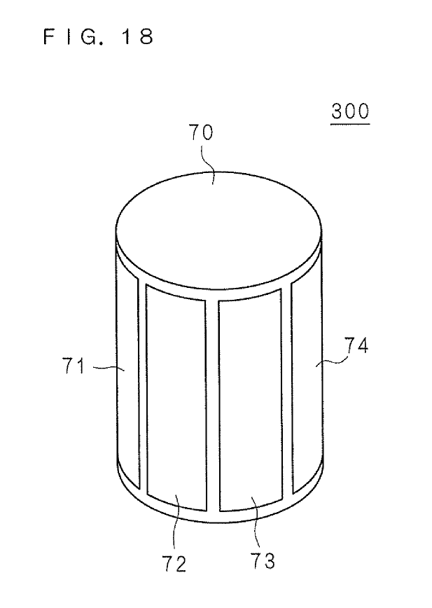

FIG. 18 is an external perspective view of a light source device 300 of Embodiment 3. As illustrated in FIG. 18, the light source device 300 is mountable to a wall or a post (not shown) mounted on the ground. A plurality of acrylic plates 71, 72, 73 and 74 are attached to the circumference of a substantially cylindrical housing 70. The parent module 10 and child module 20 are arranged toward a radial direction along a circumferential direction. Letters, symbols, figures or patterns are drawn on the acrylic plates 71 . . . . With the stored chip LEDs 1, the entire acrylic plates 71 . . . evenly emit light at a desired illuminance level.

As explained above, since the present invention is configured with a group of a plurality of modules and does not need to provide a driving circuit for every module, electric power loss in the entire light source device is reduced. Moreover, since the driving circuit is shared, electric power loss in the entire light source device is reduced. Furthermore, the degree of freedom in arranging a plurality of modules in the light source device is increased, and flexible arrangement is realized. In the case where the light source device is used for a signboard, sign, etc., the number of light sources (for example, chip LEDs) is increased or decreased according to the shape and size of the signboard, sign etc., and thus it is possible to use the light source device for signboards, signs, etc. of different shapes and sizes. Even when the number of the parent modules 10 and child modules 20 is increased or decreased according to the shape and size of a signboard, sign, etc., the number of LEDs per area of substrate is the same, thereby achieving uniform brightness irrespective of the shape and size of the signboard or the sign. In addition, it is possible to match the light source device with the shape and size of a signboard, a sign, etc. by increasing or decreasing the number of the parent modules or child modules. Moreover, it is possible to arrange a similar current to flow in the chip LED of each child module irrespective of the number of child modules to be driven by the parent module. Furthermore, it is possible to easily connect the parent modules with each other, connect the child modules with each other, or connect the parent module and the child module.

In the above-described embodiment, with the use of the chip LED as a light source, the life of the light source device is increased and electric power is saved. However, the light source is not limited only to the chip LED, and it is also possible to use a light bulb or other light emitting element.

Although the above-described embodiment explains the case where the light source device is applied to a signboard, the light source device according to the present invention is not limited to the use for signboards and is also applicable to an illumination apparatus having a planar light emitting section, such as a signboard, a display board, and lighting equipment. In addition, the light source device can be used in any place irrespective of indoor or outdoor.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A light source device having a plurality of modules, comprising:
a plurality of the modules forming a group and including
a first module having a light source for each group; and
a second module having a driving circuit for driving the light source of the first module.

2. The light source device according to claim 1, wherein the group includes a plurality of first modules, and that the light source of a plurality of the first modules is driven by sharing the driving circuit of the second module.

3. The light source device according to claim 1, wherein each of the first module and the second module has a plurality of connectors on its peripheral portion, and connectors to be connected to each other are selected from a plurality of the connectors according to an arrangement of the first module and the second module to allow a flexible arrangement of the first module and the second module.

4. The light source device according to claim 1, wherein the first module and the second module include a first substrate and a second substrate, respectively, on which the light sources are mounted, and have the same number of the light sources per area of substrates of the first module and the second module.

5. The light source device according to claim 4, wherein the first substrate and the second substrate have the same size.

6. The light source device according to claim 1, wherein the second module includes adjusting means for adjusting an output of the driving circuit according to the number of the first modules to be driven.

7. The light source device according to claim 1, wherein the second module and/or the first module includes a plurality of input/output connectors, and opening/closing sections connected to the connectors, respectively, and capable of opening and closing an electrical path between the connector and the driving circuit, an electrical path between the connector and an output terminal of the driving circuit, and/or an electrical path between the connector and the light source.

8. The light source device according to claim 1, wherein the light source is a light emitting diode.

9. An illumination apparatus comprising;
a light source device according to claim 1.
